(19) United States
(12) Patent Application Publication
(10) Pub. No.: US 2015/0262013 A1
(43) Pub. Date: Sep. 17, 2015

(54) IMAGE PROCESSING APPARATUS, IMAGE PROCESSING METHOD AND PROGRAM

(71) Applicant: Sony Corporation, Tokyo (JP)

(72) Inventors: Yuya YAMASHITA, Kanagawa (JP); Hironori HATTORI, Kanagawa (JP)

(73) Assignee: Sony Corporation, Tokyo (JP)

(21) Appl. No.: 14/633,842

(22) Filed: Feb. 27, 2015

(30) Foreign Application Priority Data
Mar. 17, 2014 (JP) 2014-053666

(51) Int. Cl. G06K 9/00; G06T 11/60; G06T 7/00

(52) U.S. Cl. CPC G06K 9/00624; G06T 7/0051; G06T 11/60

(57) ABSTRACT

There is provided an image processing apparatus including a detection unit configured to detect a marker to be a mark for attaching an image, from a captured image captured by an imaging apparatus, a determination unit configured to determine a change in state of the marker, and an image processing unit configured to generate a first image obtained by attaching a marker corresponding image corresponding to the marker to a position of the marker in the captured image, and change the first image to a second image according to the change in state of the marker.

### CROSS REFERENCE TO RELATED APPLICATIONS

This application claims the benefit of Japanese Priority Patent Application JP 2014-053666 filed Mar. 17, 2014, the entire contents of which are incorporated herein by reference.

### BACKGROUND

The present technology relates to an image processing apparatus, an image processing method, and a program. Specifically, it relates to an image processing apparatus, an image processing method, and a program that allow a subject to be captured by an imaging apparatus to easily change an image.

There has been disclosed a technology as a method that allows a person to be a subject of an imaging apparatus (camera) that captures an image to control the apparatus (see, for example, JP H9-185456A, JP 2013-187907A and JP 2013-192151A).

A gesture of the subject in a captured image captured by the imaging apparatus is recognized, and the apparatus is controlled according to the gesture (see JP H9-185456A and JP 2013-187907A).

A color displayed on a control terminal held by the subject to be captured by the imaging apparatus is recognized, and the apparatus is controlled according to the movement of the color (see JP 2013-192151A).

According to the technologies described above, since the subject himself/herself to be captured by the imaging apparatus can operate the apparatus, the person to be the subject can control the apparatus in desired timing. Further, since it is not expected to assign a person who operates the apparatus in addition to the person to be the subject, the person who operates the apparatus can be eliminated.

### SUMMARY

For example, in the technology that controls the apparatus by using the gesture as described in JP H9-185456A and JP 2013-187907A, the subject himself/herself who makes a gesture and the gesture (motion) of the subject is expected to be recognized. Therefore, in the technology that controls the apparatus by using the gesture, since the figure and the motion of the subject having an individual difference is expected to be recognized, it may be difficult to enhance recognition accuracy and securely control the apparatus.

Moreover, for example, in the technology that controls the apparatus by using the control terminal as described in JP 2013-192151A, the special control terminal is expected to be prepared.

The present technology has been developed in view of such a situation, and it may allow a subject to be captured by an imaging apparatus to easily control the apparatus, thereby allowing the subject to easily change an image.

According to an embodiment of the present disclosure, there is provided an image processing apparatus including a detection unit configured to detect a marker to be a mark for attaching an image, from a captured image captured by an imaging apparatus, a determination unit configured to determine a change in state of the marker, and an image processing unit configured to generate a first image obtained by attaching a marker corresponding image corresponding to the marker to a position of the marker in the captured image, and change the first image to a second image according to the change in state of the marker, or a program for allowing a computer to function as the image processing apparatus.

According to another embodiment of the present disclosure, there is provided an image processing method including detecting a marker to be a mark for attaching an image, from a captured image captured by an imaging apparatus, determining a change in state of the marker, and generating a first image obtained by attaching a marker corresponding image corresponding to the marker to a position of the marker in the captured image, and changing the first image to a second image according to the change in state of the marker.

According to an embodiment of the present technology, a marker to be a mark for attaching an image is detected from a captured image captured by an imaging apparatus, and a change in state of the marker is determined. A first image is then generated in which a marker corresponding image corresponding to the marker is attached to a position of the marker in the captured image, and the first image is changed to a second image according to the change in state of the marker.

The program may be provided in the form of being transmitted via a transmission medium or being recorded in a recording medium.

Note that the image processing apparatus may be an independent apparatus or may be an internal block that constitutes one apparatus.

According to an embodiment of the present technology, it may be possible for a subject to be captured by an imaging apparatus to easily change an image.

Note that an effect described herein is not necessarily limited thereto and may be any effect described in the present disclosure.

### BRIEF DESCRIPTION OF THE DRAWINGS

FIG. 1 is a block diagram showing a configuration example of an image processing system according to an embodiment of the present technology;

FIG. 2 is a diagram showing an example of a marker;

FIG. 3 is a diagram showing an example of a captured image and a first image in which a marker corresponding image is attached to a position of the marker in the captured image;

FIG. 4 is a flow chart explaining an example of processing of the image processing system;

FIG. 5 is a diagram showing a first example of a change in state of the marker and an effect performed according to the change in state of the marker;

FIG. 6 is a diagram showing a second example of the change in state of the marker and the effect performed according to the change in state of the marker;

FIG. 7 is a diagram showing a third example of the change in state of the marker;

FIG. 8 is a diagram showing an example of a change in state of the marker in which a hidden portion is changed;

FIG. 9 is a diagram showing a first example of a change in state in which the marker is partially hidden;

FIG. 10 is a diagram showing a second example of the change in state in which the marker is partially hidden; and

FIG. 11 is a block diagram showing a configuration example of a computer according to an embodiment of the present technology.

### DETAILED DESCRIPTION OF THE EMBODIMENT(S)

### Embodiment of Image Processing System to which Present Technology is Applied

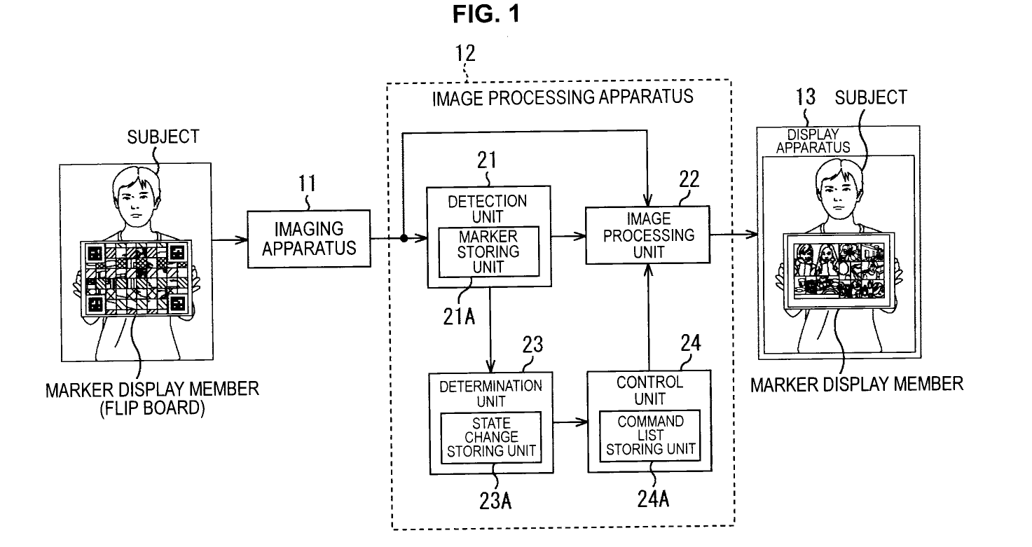

FIG. 1 is a block diagram showing a configuration example of an image processing system according to an embodiment of the present technology.

In FIG. 1, the image processing system includes an imaging apparatus 11, an image processing apparatus 12, and a display apparatus 13, and, for example, it may configure an editing system that edits a captured image captured by the imaging apparatus 11 to produce a program (content) called a so-called full package.

The imaging apparatus 11 may be, for example, a video camera that captures an image (moving image), and it captures a subject or the like to supply a captured image obtained by the capturing to the image processing apparatus 12.

Here, in FIG. 1, a person being a subject holds a marker display member, and therefore a captured image taken with the subject (person) and the marker display member is captured by the imaging apparatus 11.

The marker display member is a member on which a marker is indicated, and the marker is a still image to be a mark for attaching an image.

As the marker display member, for example, a flip board on which a marker (an image to be the marker) is printed or handwritten may be adopted. Further, as the marker display member, for example, any presenting section capable of presenting an image (in a form allowing the imaging apparatus 11 to capture), such as a tablet terminal or the like capable of displaying a marker, may be adopted.

The presenting section adopted as the marker display member may be, for example, a flat-plate presenting section such as a tablet terminal, a liquid crystal panel or the like, and may be, for example, a curved-surface presenting section such as one obtained by curving an organic electro luminescence (EL) panel.

Moreover, when a tablet terminal capable of displaying a moving image is adopted as the marker display member, the moving image may be adopted as a marker instead of a still image. When the moving image is adopted as the marker, however, since the detection of the marker may take some time, it may be desirable to adopt a still image as the marker in terms of the prompt detection of the marker. The image processing apparatus 12 is, for example, a switcher in the editing system as the image processing system of FIG. 1, and subjects the captured image supplied from the imaging apparatus 11 to a wide variety of image processing.

That is, the image processing apparatus 12 generates a first image obtained by attaching (combining) a marker corresponding image corresponding to a maker to a position of the marker in the captured image supplied from the imaging apparatus 11, and supplies the first image to the display apparatus 13.

Moreover, the image processing apparatus 12 changes the first image to a second image according to a change in state (state change) of the marker in the captured image supplied from the imaging apparatus 11, and supplies the second image to the display apparatus 13.

Specifically, the image processing apparatus 12 includes a detection unit 21, an image processing unit 22, a determination unit 23, and a control unit 24.

The captured image from the imaging apparatus 11 is supplied to the detection unit 21.

The detection unit 21 analyzes the captured image from the imaging apparatus 11 for every one or more frames, detects a marker displayed in the marker display member from the captured image, and supplies marker information on a position, a posture and the like of the marker to the image processing unit 22 and the determination unit 23.

That is, the detection unit 21 incorporates a marker storing unit 21A, and marker image information (for example, a feature amount and the like of an image) indicating the image to be the marker is stored in the marker storing unit 21A.

The detection unit 21 detects, as the marker, (an image of) a region that matches the image indicated by the marker image information stored in the marker storing unit 21A from the captured image from the imaging apparatus 11, and supplies the marker information on the marker to the image processing unit 22 and the determination unit 23.

To the image processing unit 22, the marker information is supplied from the detection unit 21 and the captured image is supplied from the imaging apparatus 11.

The image processing unit 22 specifies the marker on the captured image from the imaging apparatus 11 on the basis of the marker information from the detection unit 21, generates the first image obtained by attaching the marker corresponding image corresponding to the marker to the position of the marker in the captured image, and supplies the first image to the display apparatus 13.

Here, as the marker corresponding image, for example, computer graphics (CG), or a captured image (a moving image or a still image) captured by another imaging apparatus may be adopted. In the image processing unit 22, for example, the marker is associated with the marker corresponding image, and the first image is generated by attaching the marker corresponding image corresponding to the marker to the position of the marker in the captured image.

Further, the image processing unit 22 changes the first image to the second image by subjecting the first image to an effect, and supplies the second image to the display apparatus 13.

Here, as the effect to which the first image is subjected, for example, there are effects such as an effect for switching the marker corresponding image in the first image to another image, and an effect for bringing the marker corresponding image in the first image into full-screen display.

Note that, as the second image, an image obtained by subjecting the first image to an effect, an entirely different image from the first image, an image obtained by subjecting this image to an effect, or the like may be adopted.

The determination unit 23 incorporates a state change storing unit 23A, and in the state change storing unit 23A, there is stored state change information indicating a state change of the marker, that is, one or more state changes of, for example, a state change in which a position or a posture of the marker is changed, a state change in which the marker becomes partially hidden, a state change in which a hidden portion of the marker is changed, and the like.

The determination unit 23 determines a state change of the marker by using the marker information for a certain period from the detection unit 21, and the state change information stored in the state change storing unit 23A, and when a state change indicated by the state change information stored in the state change storing unit 23A is generated in the marker, supplies the state change information indicating the state change of the marker to the control unit 24.

The control unit 24 incorporates a command list storing unit 24A, and in the command list storing unit 24A, there is stored a command list on which the state change information is registered in association with a command indicating an effect to be executed when the state change of the marker indicated by the state change information is generated.

The control unit 24 selects a command in association with the state change information from the determination unit 23, from the command list stored in the command list storing unit 24A, and supplies the command to the image processing unit 22, thereby allowing the image processing unit 22 to execute an effect indicated by the command.

Here, as described above, the image processing unit 22 subjects the first image to the effect according to the command from the control unit 24 to thereby change the first image to the second image. This command is a command in association with the state change information obtained in the determination unit 23. Accordingly, in the image processing unit 22, the first image is subjected to the effect according to the state change of the marker in the captured image, which is determined by the determination unit 23, so that the first image is changed to the second image.

The display apparatus 13 is a monitor for confirmation of the editing result (full package) of the captured image obtained in the editing system as the image processing system of FIG. 1. The display apparatus 13 is configured by, for example, a liquid crystal panel and the like, and displays the first image or the second image supplied from (the image processing unit 22 of) the image processing apparatus 12.

In the editing system as the image processing system configured as described above, the imaging apparatus 11 captures the captured image taken with the person as the subject holding the marker display member, and supplies the captured image to the detection unit 21 and the image processing unit 22 of the image processing apparatus 12.

The detection unit 21 detects the marker displayed in the marker display member from the captured image supplied from the imaging apparatus 11, and supplies the marker information on the marker to the image processing unit 22 and the determination unit 23.

The image processing unit 22 generates the first image obtained by attaching the marker corresponding image corresponding to the marker to the position of the marker in the captured image from the imaging apparatus 11, on the basis of the marker information from the detection unit 21, and supplies the first image to the display apparatus 13.

In FIG. 1, the display apparatus 13 displays the first image, which is generated in the image processing unit 22 as described above, obtained by attaching, for example, CG as the marker corresponding image corresponding to the marker to the position of the marker in the captured image.

Meanwhile, the determination unit 23 determines the state change of the marker by using the marker information from the detection unit 21, and when the state change indicated by the state change information stored in the state change storing unit 23A is generated in the marker, supplies the state change information indicating the state change of the marker to the control unit 24.

The control unit 24, when being supplied with the state change information from the determination unit 23, selects the command in association with the state change information from the determination unit 23, from the command list stored in the command list storing unit 24A, and supplies the command to the image processing unit 22.

The image processing unit 22 subjects the first image to the effect according to the command from the control unit 24 to change the first image to the second image, and supplies the second image to the display apparatus 13.

The display apparatus 13 displays the second image in place of the first image.

### Example of Marker

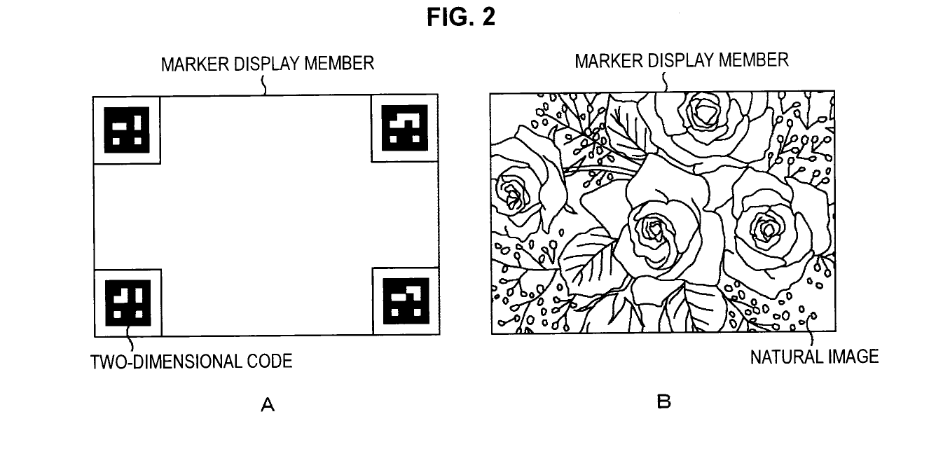

FIG. 2 is a diagram showing an example of the marker.

In FIG. 2, as the marker display member, for example, a flip board configured by a rectangular cardboard or the like is adopted.

FIG. 2A shows an example of (a still image including) a two-dimensional code as the marker.

In FIG. 2A, the two-dimensional codes as the marker are printed at four corners of the rectangular cardboard.

As for the two-dimensional code as the marker of FIG. 2A, the detection unit 21 detects a rectangular region surrounded by the two-dimensional codes printed at the four corners of the flip board, as the marker.

FIG. 2B shows an example of (a still image of) a natural image as the marker.

In FIG. 2B, the natural image as the marker is printed on the whole surface of the rectangular flip board.

As for the natural image as the marker of FIG. 2B, the detection unit 21 detects a rectangular region of the natural image printed on the whole surface of the flip board, as the marker.

As the marker, in addition to the two-dimensional code or the natural image as described above, a combination of the two-dimensional code and the natural image, CG, and any other still image may be adopted.

Note that it is desirable that the marker is a still image having a somewhat complicated pattern, which is not expected to appear in the captured image, so as to be easily detected from within the captured image. The adoption of the still image having a somewhat complicated pattern as the marker allows the detection unit 21 to detect (a position, a posture and the like of) the marker at high accuracy, and further allows the determination unit 23 to determine a small state change of the marker.

### Example of Captured Image and First Image

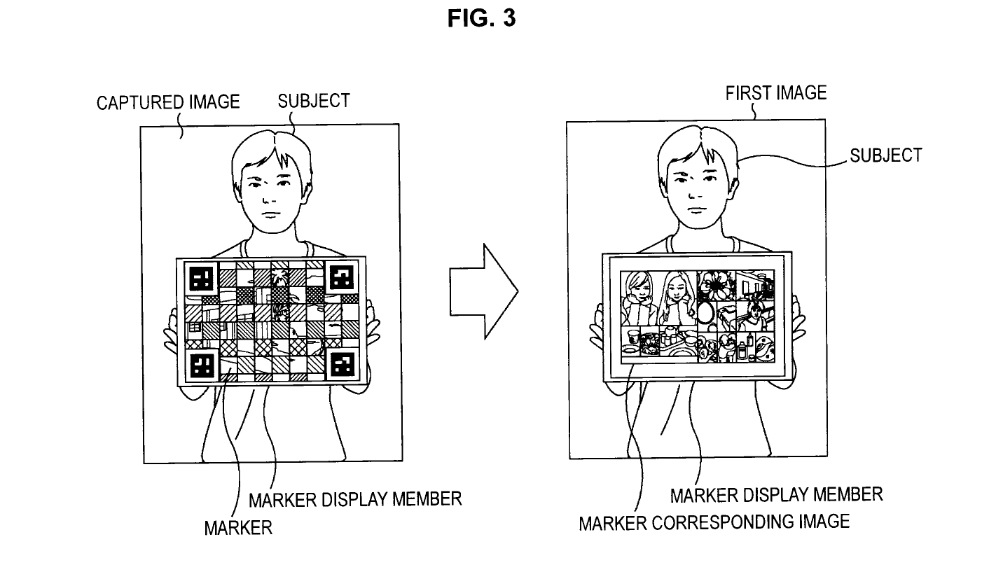

FIG. 3 is a diagram showing an example of the captured image and the first image in which the marker corresponding image is attached to a position of the marker in the captured image.

In the captured image of FIG. 3, the marker display member and the person as the subject holding the marker display member in front of his chest are captured.

On the marker display member of FIG. 3, there is printed as the marker a still image in which an image having small-sized rectangular images arranged in a mosaic form is combined with two-dimensional codes. Moreover, in FIG. 3, the two-dimensional codes are printed at four corners of the rectangular marker display member, and the use of the two-dimensional codes allows mainly the four corners of the marker (eventually the region in which the marker exists on the captured image) to be detected at high accuracy.

In FIG. 3, the predetermined image as the marker corresponding image corresponding to the marker is attached to the position of the marker in the captured image as described above to generate the first image.

Therefore, in the first image, the region of the marker indicated in the marker display member is replaced with the marker corresponding image, and the first image is an image different from the captured image in this respect.

### Processing of Image Processing System

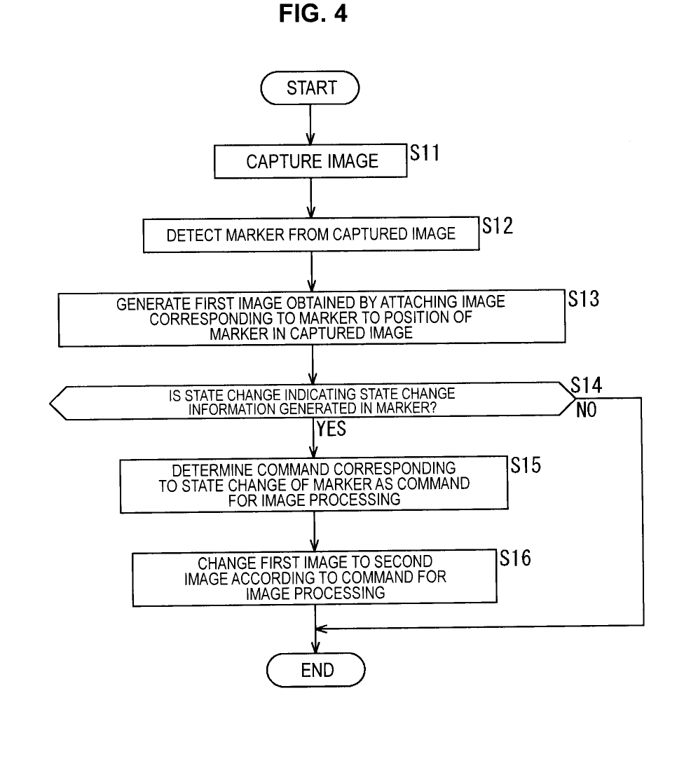

FIG. 4 is a flow chart explaining an example of processing of the image processing system of FIG. 1.

At Step S11, the imaging apparatus 11 captures, for example, the captured image taken with the person as the subject holding the marker display member, and supplies the captured image to the detection unit 21 and the image processing unit 22 of the image processing apparatus 12. The processing then proceeds to Step 12.

At Step S12, the detection unit 21 detects the marker from the captured image from the imaging apparatus 11, and supplies the marker information on the marker to the image processing unit 22 and the determination unit 23. The processing then proceeds to Step S13.

At Step S13, the image processing unit 22 recognizes (the region of) the marker in the captured image from the imaging apparatus 11 on the basis of the marker information from the detection unit 21. The image processing unit 22 then attaches the marker corresponding image corresponding to the marker to the position of the marker in the captured image to generate the first image, and supplies the first image to the display apparatus 13. The processing then proceeds to Step S14.

In this manner, the display apparatus 13 displays the first image in which the marker corresponding image corresponding to the marker is attached to the position of the marker in the captured image.

At Step S14, the determination unit 23 determines the state change of the marker by using the marker information from the detection unit 21, and the state change information stored in the state change storing unit 23A.

That is, at Step S14, the determination unit 23 determines whether the state change indicated by the state change information stored in the state change storing unit 23A is generated in the marker.

When it is determined that the state change indicated by the state change information is not generated in the marker at Step S14, the processing skips Steps S15 and S16 and ends.

In this case, the display apparatus 13 continues to display the first image.

Meanwhile, when it is determined that the state change indicated by the state change information is generated in the marker at Step S14, that is, when the subject holding the marker display member carries out an act of changing the state of the marker display member, such as waving the marker display member, to generate the state change in which the state of the marker indicated on the marker display member is changed, and the state change corresponds to the state change indicated by the state change information stored in the state change storing unit 23A, the determination unit 23 supplies the state change information indicating the state change of the marker to the control unit 24. The processing then proceeds to Step S15.

At Step S15, the control unit 24 determines (selects) the command in association with the state change information from the determination unit 23, that is, the command corresponding to the state change of the marker from the command list stored in the command list storing unit 24A, as the command instructing the image processing to be performed by the image processing unit 22, and supplies the command to the image processing unit 22. The processing then proceeds to Step S16.

At Step S16, the image processing unit 22 subjects the first image to the effect according to the command from the control unit 24 to change the first image to the second image, and supplies the second image to the display apparatus 13. The processing then ends.

In this case, the display apparatus 13 displays the second image in place of the first image.

Accordingly, according to the image processing system of FIG. 1, when the subject holding the marker display member simply carries out an act of generating the state change indicated by the state change information for the mark display member, (the effect performed in) the image processing unit 22 is controlled according to the state change of the marker, thereby allowing the image displayed on the display apparatus 13 to be changed to the second image obtained by the effect performed in the image processing unit 22.

In this manner, the subject holding the marker display member can easily change the image displayed on the display apparatus 13 from the first image to the second image.

### Example of State Change of Marker and Effect Preformed According to State Change of Marker

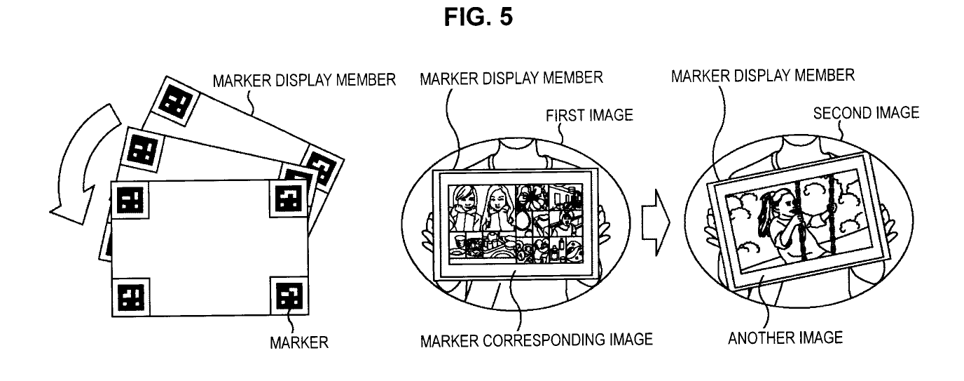

FIG. 5 is a diagram showing a first example of the state change of the marker and the effect performed according to the state change of the marker.

In FIG. 5, the act of waving the rectangular flip board as the marker display member having the marker indicated thereon so as to incline it centering around the position near the right lower corner is conducted, thereby generating the state change in which the marker is inclined in a plane perpendicular to a depth direction.

Then, in FIG. 5, the effect for switching the marker corresponding image in the first image to another image is provided according to the state change in which the marker is inclined in the plane perpendicular to the depth direction, thereby generating the second image in which the marker corresponding image in the first image is switched to another image.

In FIG. 5, the subject holding the marker display member can switch the marker corresponding image to another image simply by waving the marker display member.

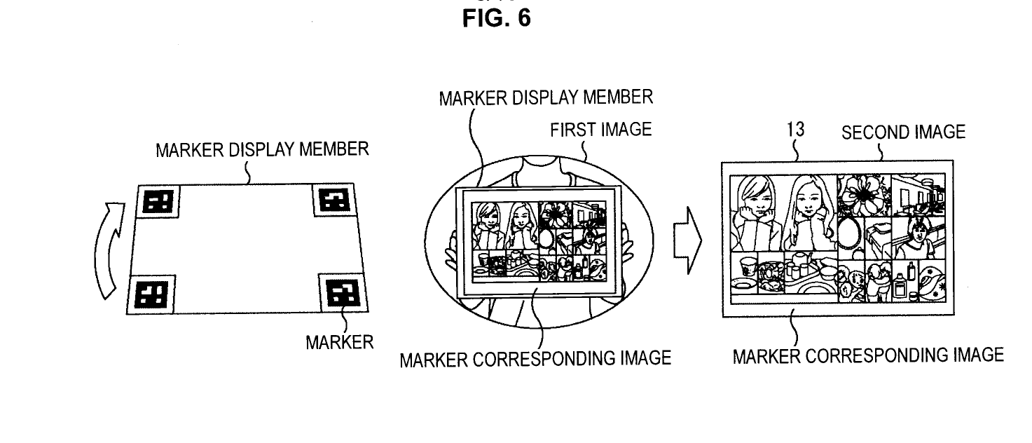

FIG. 6 is a diagram showing a second example of the state change of the marker and the effect performed according to the state change of the marker.

In FIG. 6, the act of waving the rectangular flip board as the marker display member having the marker indicated thereon so as to incline it in the depth direction (a backward direction or a frontward direction) is conducted, thereby generating the state change in which the marker is inclined in the depth direction (in FIG. 6, the state change in which the upper portion of the marker is inclined to a depth side).

Then, in FIG. 6, the effect for bringing the marker corresponding image in the first image into the full-screen display is provided according to the state change in which the marker is inclined in the depth direction, thereby generating the second image in which the marker corresponding image in the first image is brought into the full-screen display on the display apparatus 13.

In FIG. 6, the subject holding the marker display member can switch the marker corresponding image displayed on the marker display member to the full-screen display simply by inclining the marker display member in the depth direction.

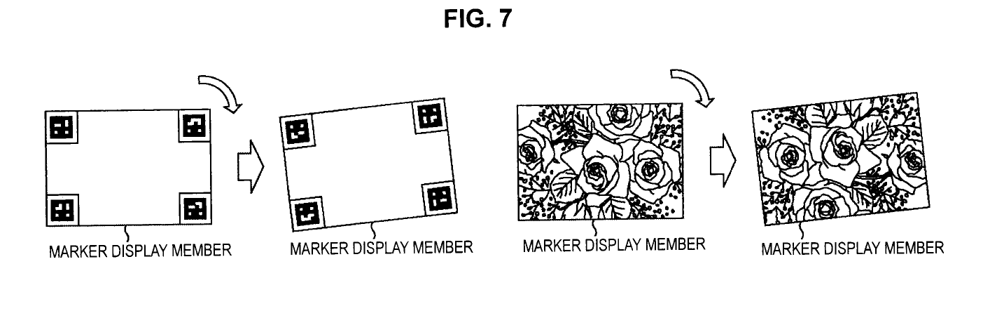

FIG. 7 is a diagram showing a third example of the state change of the marker.

In FIG. 7, the act of rotating half the rectangular flip board as the marker display member having the marker indicated thereon in the plane perpendicular to the depth direction is conducted, thereby generating the state change in which the marker is rotated half in the plane perpendicular to the depth direction to be upside down.

As described above, the image processing unit 22 can change the first image to the second image according to the state change in which the marker is rotated half in the plane perpendicular to the depth direction to be upside down.

Here, FIG. 7 shows the example of the state change in which the marker becomes upside down, for each of the case in which the two-dimensional code is adopted to the marker display member and the case in which the natural image is adopted to the marker display member.

As described above, the image processing unit 22 can change the first image to the second image according to a state change in which a hidden portion of the marker is changed, in addition to the state change in which the position or the posture of the marker is changed, such as the state change in which the marker is inclined in the depth direction, the state change in which the marker is inclined in the plane perpendicular to the depth direction, or the state change in which the marker becomes (vertically) upside down.

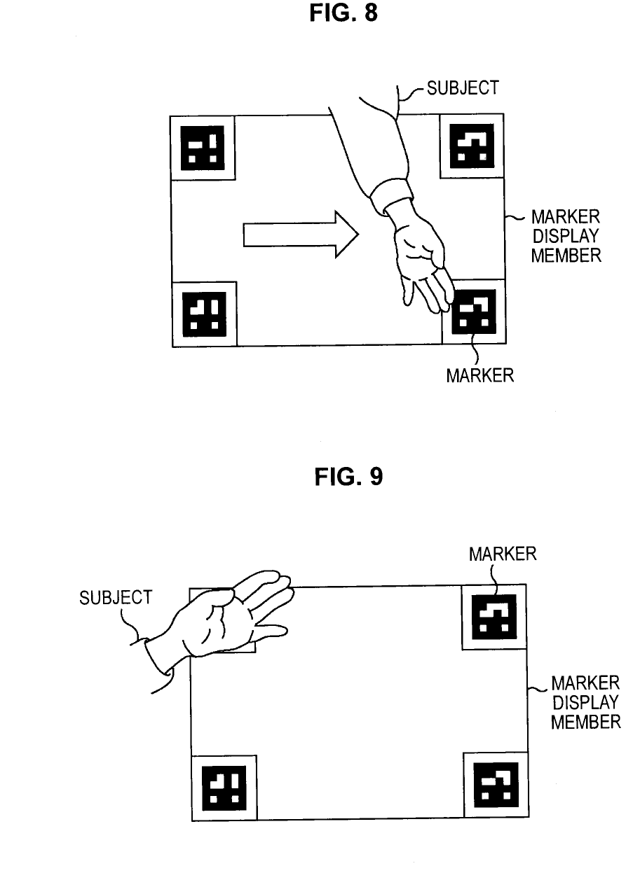

FIG. 8 is a diagram showing an example of the state change in which the hidden portion of the marker is changed.

In FIG. 8, the subject holding the marker display member conducts the act of swiping the hand in front of the marker indicated on the marker display member, thereby generating the state change in which the hidden portion of the marker by the hand is changed (moved).

As described above, the image processing unit 22 can change the first image to the second image according to the state change in which the hidden portion of the marker is changed.

In this case, the subject holding the marker display member can easily change the first image to the second simply by swiping the hand in front of the marker indicated on the marker display member.

Note that the hand (of the subject) or a tool such as a pointer may be adopted as a measure for partially hiding the marker in order to generate the state change in which the hidden portion of the marker is changed.

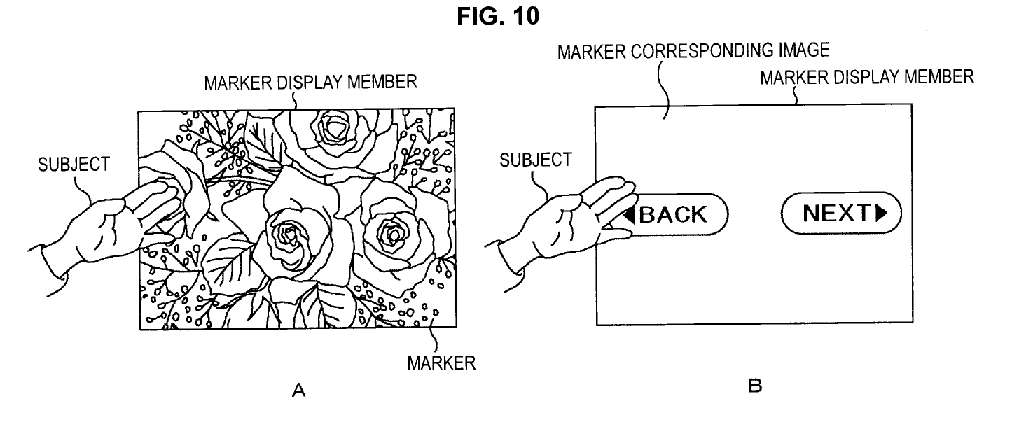

FIG. 9 is a diagram showing a first example of the state change in which the marker is partially hidden.

In FIG. 9, the subject holding the marker display member conducts the act of partially hiding the marker indicated on the marker display member by the hand, thereby generating the state change in which the marker is partially hidden.

As described above, the image processing unit 22 can change the first image to the second image according to the state change in which the marker is partially hidden.

In this case, the subject holding the marker display member can easily change the first image to the second image simply by partially hiding the marker indicated on the marker display member.

FIG. 10 is a diagram showing a second example of the state change in which the marker is partially hidden.

In FIG. 10, the subject holding the marker display member conducts the act of partially touching the marker indicated on the marker display member, thereby generating the state change in which the marker is partially hidden by the hand.

As described above, the image processing unit 22 can change the first image to the second image according to the state change in which the marker is partially hidden.

In this case, the subject holding the marker display member can easily change the first image to the second image simply by partially touching the marker indicated on the marker display member by the hand.

Here, FIG. 10A shows an example of the marker display member on which the natural image as the marker is printed, and FIG. 10B shows an example of the marker display member in which the marker corresponding image is attached (combined) to the marker of FIG. 10A.

The marker corresponding image of FIG. 10B is configured by CG of a button indicating characters of “BACK” or “NEXT”. As the editing result by the editing system as the image processing system of FIG. 1, the first image to which the marker corresponding image of FIG. 10B is attached is displayed on the display apparatus 13.

Therefore, the image (first image) viewed by a viewer includes the marker corresponding image as the CG of the button, and the first image is changed to the second image according to the state change in which the portion of the marker corresponding to the button as the marker corresponding image is hidden. Accordingly, it may be possible to realize such a performance that, when the subject holding the marker display member touches (the portion of the marker corresponding to) the button as the marker corresponding image, the first image is changed to the second image.

Note that the hand (of the subject) or a tool such as a pointer may be adopted as a measure for partially hiding the marker.

As described above, in the image processing system of FIG. 1, the image processing apparatus 12 detects the marker from the captured image captured by the imaging apparatus 1 and determines the state change of the marker. The image processing apparatus 12 then generates the first image obtained by attaching the marker corresponding image corresponding to the marker to the position of the marker in the captured image, and generates the second image, for example, by subjecting the first image to the effect according to the state change of the marker, so that the first image is changed to the second image.

Therefore, the subject to be captured in the captured image can easily control the image processing unit 22 of the image processing apparatus 12 for providing the effect to easily change the image (obtained as the editing result) displayed on the display apparatus 13 from the first image to the second image.

Note that, in the image processing system of FIG. 1, since the captured image is used to control the image processing unit 22, that is, to control the image processing unit 22 so that the first image is subjected to the effect according to the state change of the marker indicated in the captured image, the person as the subject is not expected to operate a special control terminal for controlling the image processing unit 22.

That is, when the captured image is not used to control the image processing unit 22, for example, the special control terminal that transmits a signal such as a radio signal for controlling the image processing unit 22 is prepared, and the person as the subject is expected to control the special control terminal.

The image processing system of FIG. 1 may eliminate the demand for preparing the special control terminal.

Moreover, in the technology to control the apparatus by utilizing the gesture as described in JP H9-185456A and JP 2013-187907A described above, although the person as the subject is expected to make a special gesture for controlling the apparatus, the special gesture by the subject may cause the viewer to feel odd.

That is, for example, when the person as the subject holds the flip board by the hand and explains the content (of the marker display image) displayed on the flip board, the gesture independent of the content displayed on the flip board by the subject may cause the viewer to feel odd. Therefore, it is desirable to avoid such gesture in program production or the like.

Further, for example, in the technology to control the apparatus by using the control terminal as described in JP 2013-192151A, the person as the subject holding the special control terminal is captured in the captured image, eventually, the first image. Holding such a special control terminal by the subject also causes the viewer to feel add.

In the image processing system of FIG. 1, when the person as the subject handles the flip board so as to change the state of the marker, such as waving, inclining, partially hiding the flip board as the marker display member, or changing (moving) the hidden portion of the flip board, the image processing unit 22 can be controlled to change the first image to the second image. Accordingly, the subject can change the first image to the second image without making the gesture independent of the content displayed on the flip board (the gesture significantly deviated from the progress of the program), and without operating the special control terminal.

Therefore, the person as the subject, while allowing the viewer to pay attention to the flip board on which the marker corresponding image is displayed in the first image, can change the first image to the second image, that is, for example, can switch the image displayed on the flip board from the marker corresponding image to another image, thereby allowing a natural performance suited to the content of the program.

Moreover, in the image processing system of FIG. 1, since the first image can be changed to the second image by the handling of the flip board by the person as the subject, the subject can change the first image to the second image in his/her convenient timing. Further, since it is not expected to operate the image processing apparatus 12 in order to change the first image to the second image, the first image can be changed to the second image without an operator for operating the image processing apparatus 12.

### Configuration Example of Computer to which Present Technology is Applied

Incidentally, the above mentioned series of processes can, for example, be executed by hardware, or can be executed by software. In the case where the series of processes is executed by software, a program configuring this software is installed in a general-purpose personal computer, and the like.

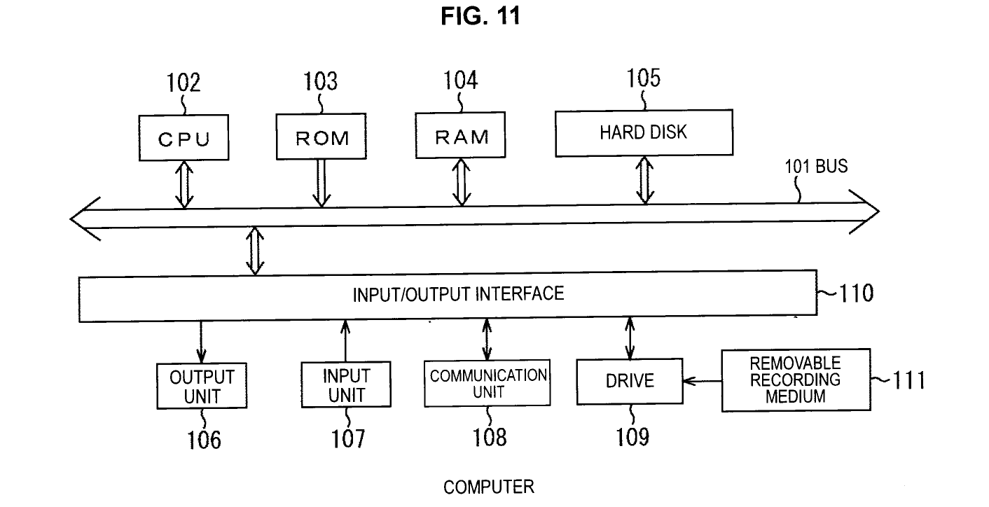

FIG. 11 shows a configuration example of one embodiment of a computer that executes the above series of processes by programs.

The program can be recorded on a hard disk 105 or a read only memory (ROM) 103 as a recording medium in advance.

Alternatively, the program can be stored (recorded) in a removable recording medium 111. The removable recording medium 111 can be provided as so-called package software. In this case, a flexible disc, a compact disc read only memory (CD-ROM), a magneto-optical (MO) disc, a digital versatile disc (DVD), a magnetic disc, and a semiconductor memory are exemplified as the removable recording medium 111.

Note that the program can be installed from the removable recording medium 111 to the computer, and also the program can be downloaded to the computer through a communication network or a broadcasting network and can be installed in the embedded hard disk 105. That is, the program can be transmitted by wireless, from a download site to the computer through an artificial satellite for digital satellite broadcasting, or can be transmitted by wire, from the download site to the computer through a network such as a local area network (LAN) or the Internet.

The computer has a central processing unit (CPU) 102 embedded therein and an input/output interface 110 is connected to the CPU 102 through a bus 101.

If a command is input to the CPU 102 through the input/output interface 110 by operating an input unit 107 by a user, the CPU 102 executes the program stored in the ROM 103, according to the command. Alternatively, the CPU 102 loads the program stored in the hard disk 105 to a random access memory (RAM) 104 and executes the program.

Thereby, the CPU 102 executes the series of processes executed by the above-described flowchart or the configuration of the block diagram described above. In addition, the CPU 102 allows an output unit 106 to output the processing result, allows a communication unit 108 to transmit the processing result, or allows the hard disk 105 to record the processing result, through the input/output interface 110, according to necessity.

Note that the input unit 107 is configured using a keyboard, a mouse, a microphone, and others. The output unit 106 is configured using a liquid crystal display (LCD), a speaker, and others.

Processing performed herein by the computer according to a program does not necessarily have to be performed chronologically in the order described in a flow chart. That is, processing performed by the computer according to a program also includes processing performed in parallel or individually (for example, parallel processing or processing by an object).

The program may be processed by one computer (processor) or by a plurality of computers in a distributed manner. Further, the program may be performed after being transferred to a remote computer.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or one apparatus, storing a plurality of modules within a single casing.

An embodiment of the disclosure is not limited to the embodiments described above, and various changes and modifications may be made without departing from the scope of the disclosure.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

In addition, the effects described in the present specification are not limiting but are merely examples, and there may be additional effects.

Additionally, the present technology may also be configured as below.

(1) An image processing apparatus including:

a detection unit configured to detect a marker to be a mark for attaching an image, from a captured image captured by an imaging apparatus;

a determination unit configured to determine a change in state of the marker; and

an image processing unit configured to generate a first image obtained by attaching a marker corresponding image corresponding to the marker to a position of the marker in the captured image, and change the first image to a second image according to the change in state of the marker.

(2) The image processing apparatus according to (1),

wherein the image processing unit changes the first image to the second image according to a state change in which a position or a posture of the marker is changed.

(3) The image processing apparatus according to (1) or (2),

wherein the image processing unit changes the first image to the second image according to a state change in which the marker is inclined in a plane perpendicular to a depth direction, or a state change in which the marker is inclined in the depth direction.

(4) The image processing apparatus according to any one of (1) to (3),

wherein the image processing unit changes the first image to the second image according to a state change in which the marker is rotated half in the plane perpendicular to the depth direction to be upside down.

(5) The image processing apparatus according to (1),

wherein the image processing unit changes the first image to the second image according to a state change in which the marker is partially hidden.

(6) The image processing apparatus according to (1),

wherein the image processing unit changes the first image to the second image according to a state change in which a hidden portion of the marker is changed.

(7) The image processing apparatus according to any one of (1) to (6),

wherein the image processing unit changes the first image to the second image by subjecting the first image to an effect.

(8) The image processing apparatus according to (7),

wherein the image processing unit provides the effect for switching the marker corresponding image in the first image to another image, or the effect for bringing the marker corresponding image in the first image into full-screen display.

(9) The image processing apparatus according to any one of (1) to (8),

wherein the marker is a still image.

(10) The image processing apparatus according to any one of (1) to (9),

wherein the marker is a two-dimensional code or a natural image.

(11) The image processing apparatus according to any one of (1) to (10),

wherein the marker is an image indicated on a flip board.

(12) An image processing method including:

detecting a marker to be a mark for attaching an image, from a captured image captured by an imaging apparatus;

determining a change in state of the marker; and

generating a first image obtained by attaching a marker corresponding image corresponding to the marker to a position of the marker in the captured image, and changing the first image to a second image according to the change in state of the marker.

(13) A program for allowing a computer to function as:

a detection unit configured to detect a marker to be a mark for attaching an image, from a captured image captured by an imaging apparatus;

a determination unit configured to determine a change in state of the marker; and

an image processing unit configured to generate a first image obtained by attaching a marker corresponding image corresponding to the marker to a position of the marker in the captured image, and change the first image to a second image according to the change in state of the marker.

What is claimed is:

1. An image processing apparatus comprising:
a detection unit configured to detect a marker to be a mark for attaching an image, from a captured image captured by an imaging apparatus;
a determination unit configured to determine a change in state of the marker; and
an image processing unit configured to generate a first image obtained by attaching a marker corresponding image corresponding to the marker to a position of the marker in the captured image, and change the first image to a second image according to the change in state of the marker.

2. The image processing apparatus according to claim 1,
wherein the image processing unit changes the first image to the second image according to a state change in which a position or a posture of the marker is changed.

3. The image processing apparatus according to claim 2,
wherein the image processing unit changes the first image to the second image according to a state change in which the marker is inclined in a plane perpendicular to a depth direction, or a state change in which the marker is inclined in the depth direction.

4. The image processing apparatus according to claim 3,
wherein the image processing unit changes the first image to the second image according to a state change in which the marker is rotated half in the plane perpendicular to the depth direction to be upside down.

5. The image processing apparatus according to claim 1,
wherein the image processing unit changes the first image to the second image according to a state change in which the marker is partially hidden.

6. The image processing apparatus according to claim 1,
wherein the image processing unit changes the first image to the second image according to a state change in which a hidden portion of the marker is changed.

7. The image processing apparatus according to claim 2,
wherein the image processing unit changes the first image to the second image by subjecting the first image to an effect.

8. The image processing apparatus according to claim 7,
wherein the image processing unit provides the effect for switching the marker corresponding image in the first image to another image, or the effect for bringing the marker corresponding image in the first image into full-screen display.

9. The image processing apparatus according to claim 2,
wherein the marker is a still image.

10. The image processing apparatus according to claim 2,
wherein the marker is a two-dimensional code or a natural image.

11. The image processing apparatus according to claim 2,
wherein the marker is an image indicated on a flip board.

12. An image processing method comprising:
detecting a marker to be a mark for attaching an image, from a captured image captured by an imaging apparatus;
determining a change in state of the marker; and
generating a first image obtained by attaching a marker corresponding image corresponding to the marker to a position of the marker in the captured image, and changing the first image to a second image according to the change in state of the marker.

13. A program for allowing a computer to function as:
a detection unit configured to detect a marker to be a mark for attaching an image, from a captured image captured by an imaging apparatus;
a determination unit configured to determine a change in state of the marker; and
an image processing unit configured to generate a first image obtained by attaching a marker corresponding image corresponding to the marker to a position of the marker in the captured image, and change the first image to a second image according to the change in state of the marker.
